(19) United States
(12) Patent Application Publication
(10) Pub. No.: US 2010/0110487 A1
(43) Pub. Date: May 6, 2010

(54) IMAGE FORMING APPARATUS AND IMAGE FORMING METHOD

(76) Inventor: Hiroki Ueda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/606,596

(22) Filed: Oct. 27, 2009

(30) Foreign Application Priority Data
Oct. 31, 2008 (JP) 2008-281952

(51) Int. Cl. G06F 15/00

(52) U.S. Cl. 358/1.15; 358/1.16

(57) ABSTRACT

Disclosed an image forming apparatus including: a nonvolatile storage section to store a print job; an input section for instructing to store the print job in the storage section; a condition setting section to allow the storage section to store a predetermined condition for enabling execution of the print job so that the predetermined condition corresponds to the print job; and a control section to execute the print job stored in the storage section, wherein the control section executes the print job when the control section judges that the predetermined condition stored in the storage section is met.

### BACKGROUND

1. Field of the Invention

The present invention relates to an image forming apparatus and an image forming method.

2. Description of Related Art

In recent years, there has been known an image forming apparatus having a reservation copy function.

The reservation copy function is a function to perform function setting for a next print job with an operation section provided in the image forming apparatus, to read a document of the next print job with a scanner, and to execute the next job when a currently running print job ends.

For example, Japanese Patent Application Laid-Open Publication No. 2001-245079 discloses a technique to record data and execution status of an interrupted print job in a hard disk when the print job is interrupted due to power-off or the like, and to invoke the data and execution status of the interrupted print job to restart the print job if it is judged that there is the record of the interrupted print job in the hard disk when the power is turned on again, in an image forming apparatus.

The print job in the printing process is stopped at proper time to stop, and the print job which has not been executed is recorded in the hard disk to be reserved to enable a user to restart the reserved job at desired timing to continue the printing.

However, according to the above related art, there is a possibility for example that the print job which a user reserved to execute on the next day is invoked by an apparatus which is turned on for performing an operation, such as maintenance in the night time, other than printing. In this case, sometimes the reserved job is lost by being deleted during execution of the maintenance or the like by an operator except the user, and there is a problem that a user needs to reset the input of the print job.

### SUMMARY

An object of the present invention is to enable execution of a print job more surely by selectively invoking the reserved print job.

In order to achieve the above-described object, according to a first aspect of the present invention, an image forming apparatus includes: a nonvolatile storage section to store a print job; an input section for instructing to store the print job in the storage section; a condition setting section to allow the storage section to store a predetermined condition for enabling execution of the print job so that the predetermined condition corresponds to the print job; and a control section to execute the print job stored in the storage section, wherein the control section executes the print job when the control section judges that the predetermined condition stored in the storage section is met.

Preferably, the control section judges whether or not the predetermined condition stored in the storage section is met in order to execute the print job stored in the storage section when a power of the image forming apparatus is turned on.

Preferably, the control section informs that the print job exists if the print job is stored in the storage section when a power of the image forming apparatus is turned on.

Preferably, the storage section stores a setting time as the condition, and control section executes the print job when the control section judges that a current time reaches the setting time or that the setting time has been passed.

Preferably, the image forming apparatus further includes an authentication input section in which a user inputs authentication information, and the control section executes the print job when the control section judges that authentication information input in the authentication input section agrees with authentication information stored in the storage section as the condition.

Preferably, the authentication information is a password.

Preferably, the authentication information is fingerprint data.

Preferably, the storage section stores a plurality of conditions, the image forming apparatus further includes a selection section in which a user arbitrary selects a condition among the plurality of conditions, and the control section performs judgment for executing the print job stored in the storage section based on the selected condition.

According to a second aspect of the present invention, an image forming method using an image forming apparatus provided with a nonvolatile storage section includes the steps of: storing a print job for forming an image and a predetermined condition for enabling execution of the print job in the storage section so that the predetermined condition corresponds to the print job; and executing the print job to form the image when the predetermined condition stored in the storage section is met.

Preferably, judging whether or not the predetermined condition stored in the storage section is met is performed when a power of the image forming apparatus is turned on.

Preferably, informing that the print job exists is performed if the print job is stored in the storage section when a power of the image forming apparatus is turned on.

Preferably, the storage section stores a setting time as the condition, and the print job is executed when the setting time has been passed.

Preferably, the image forming apparatus includes an authentication input section in which a user inputs authentication information, and the print job is executed when authentication information input in the authentication input section agrees with authentication information stored in the storage section as the condition.

Preferably, the authentication information is a password.

Preferably, the authentication information is fingerprint data.

Preferably, the storage section stores a plurality of conditions, the image forming apparatus includes a selection section in which a user arbitrary selects a condition among the plurality of conditions, and judgment for executing the print job stored in the storage section is performed based on the condition selected in the selection section.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a schematic cross-section diagram showing an image forming apparatus;

FIG. 2 is a control block diagram of the image forming apparatus;

FIG. 3 is a flowchart showing print job storing processing according to a first embodiment;

FIG. 4 is a flowchart showing print job invoking processing according to the first embodiment;

FIG. 5 is an explanatory diagram showing an example of a display screen in an operating/displaying section;

FIG. 6 is an explanatory diagram showing an example of a display screen in an operating/displaying section;

FIG. 7 is a flowchart showing a different pattern of the print job invoking processing according to the first embodiment;

FIG. 8 is an explanatory diagram showing an example of a display screen in an operating/displaying section;

FIG. 9 is an explanatory diagram showing an example of a display screen in an operating/displaying section;

FIG. 10 is a flowchart showing print job storing processing according to a second embodiment;

FIG. 11 is a flowchart showing print job invoking processing according to the second embodiment;

FIG. 12 is an explanatory diagram showing an example of a display screen in an operating/displaying section;

FIG. 13 is a flowchart showing print job storing processing according to a third embodiment;

FIG. 14 is a flowchart showing print job invoking processing according to the third embodiment;

FIG. 15 is an explanatory diagram showing an example of a display screen in an operating/displaying section;

FIG. 16 is a flowchart showing print job storing processing according to a fourth embodiment;

FIG. 17 is a flowchart showing print job invoking processing according to the fourth embodiment; and

FIG. 18 is an explanatory diagram showing an example of a display screen in an operating/displaying section.

### DETAILED DESCRIPTION OF THE PREFERRED EMBODIMENT

Hereinafter the embodiment of the present invention will be described in detail with reference to drawings below.

### First Embodiment

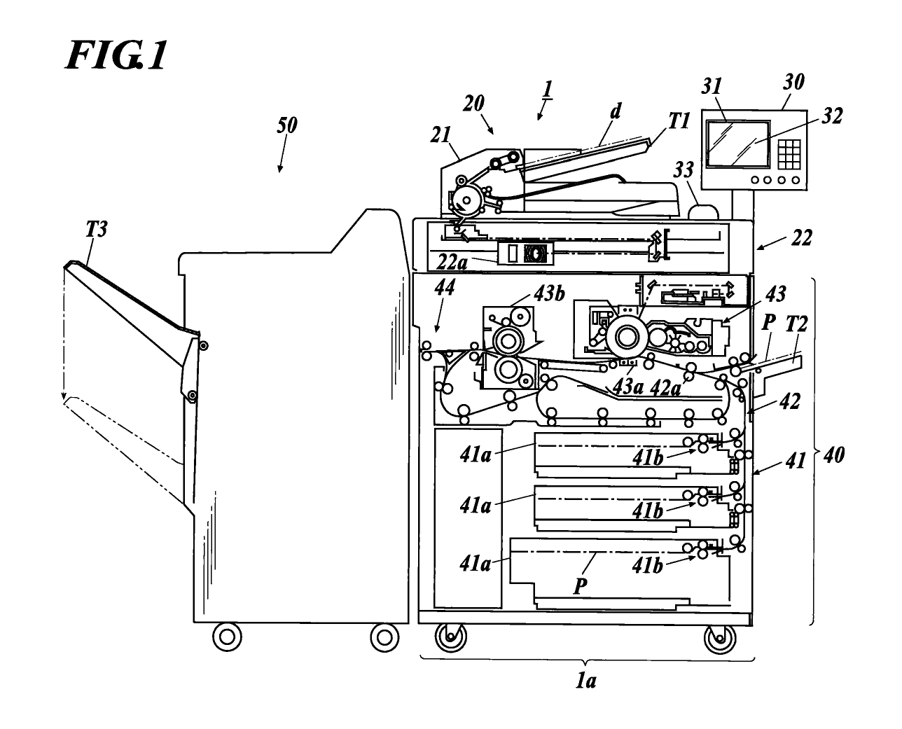

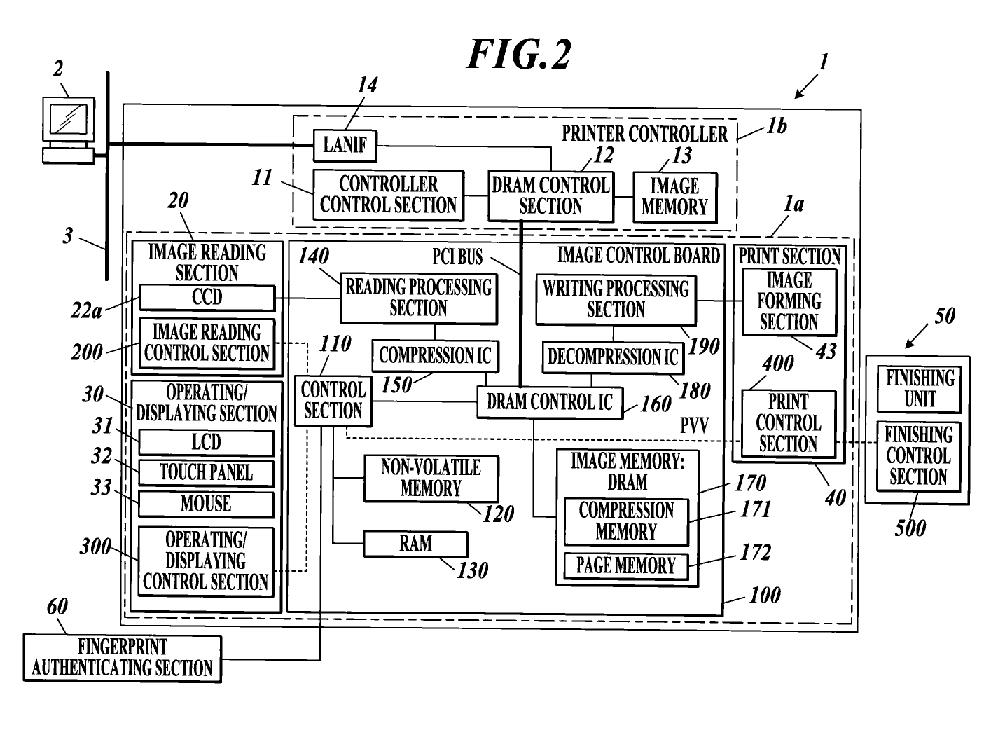

FIG. 1 is a schematic cross-section diagram of an image forming apparatus 1 according to the present invention, and FIG. 2 is a control block diagram of the image forming apparatus 1.

As shown in FIG. 1, the image forming apparatus 1 is a multifunction peripheral provided with: a body portion 1a which reads an image from an original document to form the read image on a sheet P, obtains a print job which contains page data including an image data, and configuration information such as an image forming condition (both sides mode, single side mode and the like) and finishing processing condition (stapling position, stapling direction and the like) from an external apparatus or the like to form the image on the sheet P based on the obtained print job, and sets the print job to which the image forming condition and the like are added with respect to the image read from the document by a user to form the image on the sheet P based on the set print job; a finishing processing section 50 to perform finishing processing to the sheet on which the image is formed; and so on.

The body portion 1a is configured to include an image reading section 20, an operating/displaying section 30, a printing section 40 and the like.

The image reading section 20 is provided with an automatic document feeding section 21 termed Auto Document Feeder (ADF) and a reading section 22, and realizes a function to read images of a plurality of documents based on the configuration information input from the operating/displaying section 30. The document d placed on a document tray T1 of the automatic document feeding section 21 is conveyed onto a contact glass as a reading position, and then the image of single side or both sides of the document d is scanned with optical system to be read by Charge Couple Device (CCD) 22a. The image includes not only image data such as a graphic and photograph but also text data such as a character and mark.

The image data (analog data) read by the image reading section 20 is output to a reading processing section 140 of an image control board 100 described below, subjected to A/D conversion and various image processing in the reading processing section 140 to be output to the printing section 40.

The operating/displaying section 30 is provided with Liquid Crystal Display (LCD) 31, a touch panel configured to cover the LCD 31, a mouse 33, not-shown operation keys, and so on. The operating/displaying section 30 receives an instruction from a user to output an operation signal to a control section 110, and displays various setting screens for inputting various operation instructions and configuration information, and various processing results, according to a display signal input from the control section 110.

The LCD 31 functions as a display section to display a plurality of buttons indicating various operation instructions, and various screens.

The touch panel 32 functions as an input section which detects a position of the touch instruction according to reading-position principle such as electromagnetic guidance, magnetostrictive and pressure-sensitive method for example, and enables inputting of various pieces of data and inputting of operation instructions depending on the detected position.

The operating/displaying section 30 outputs the operation signal indicating the instruction received on the screen via buttons on the various screens and the like to the control section 110 described below.

The printing section 40 is configured to perform image forming processing by electrophotographic method based on the input print data, and provided with a feeding section 41, sheet conveyance section 42, image forming section 43 and discharge section 44.

The feeding section 41 includes a plurality of feeding trays 41a, a feeding member 41b, a manual feeding tray T2, and so on. The feeding tray 41a houses the sheets P which are conveyed one by one from the upper side to the sheet conveyance section 42 with the feeding member 41b. Various kinds of sheets P can be loaded on the manual feeding tray T2 depending on needs of a user, and the loaded sheets P is conveyed one by one from the upper side to the sheet conveyance section 42 with feed rollers.

The sheet conveyance section 42 conveys the sheet P conveyed from the feeding tray 41a or the manual feeding tray T2 to a transfer device 43a through a plurality of intermediate rollers, resist roller 42a, and so on.

The sheet conveyance section 42 further conveys the sheet P a single surface of which has been processed to a both-sides conveyance path with a conveyance switching plate, and conveys the sheet P to the transfer device 43a through the intermediate roller and the resist roller 42a again.

The image forming section 43 includes: a photosensitive drum; a charging device; an exposure device provided with a laser output section to output laser light based on the image data, and a polygon mirror to allow the laser light to scan in scanning direction; a development device; the transfer device 43a; a cleaning section; and a fixing section 43b. The image forming section 43 realizes a function to form the image on the sheet P based on the print job stored in a RAM 130 or nonvolatile memory 120 described below.

Specifically, the exposure device irradiates the photosensitive drum charged by the charging device with the laser light so that an electrostatic latent image is formed. Then, the development device allows charged toner to adhere to a surface of the photosensitive drum on which the electrostatic image is formed to develop the electrostatic image. The toner image formed on the photosensitive drum by the development device is transferred on the sheet P in the transfer device 43a. After the toner image is transferred to the sheet P, residual toner and the like on the surface of the photosensitive drum is removed by the cleaning section.

Incidentally, though illustration is omitted, sections of the image forming section 43 except the fixing section 43b are provided for four colors of yellow, magenta, cyan and black.

The fixing section 43b heat-fixes the transferred toner image on the sheet P conveyed by the sheet conveyance section 42. The sheet P which was subjected to fixing processing is conveyed from a discharging exit to the finishing section 50 while being put between discharge rollers of the discharge section 44.

The finishing section 50 includes: various finishing units such as a sort section to perform sorting processing of the image-formed sheet, a punch section to perform punching processing, a staple section to perform stapling processing to staple a bundle of the sheet depending on set stapling direction and stapling position, a fold section to perform folding processing, a cutting unit to perform cutting processing, and so on; and a plurality of discharge trays T3 onto which the various processed or non-processed sheets are discharged to be loaded.

The image forming apparatus 1 further includes, as shown in FIG. 2, the body portion 1a and a printer controller 1b, and the finishing section 50 and a fingerprint authenticating section 60 which are connected to the body portion.

The image forming apparatus 1 is connected to an external apparatus 2 on a network 3 through a Local Area Network InterFace (LANIF) 14 of the printer controller lb so that the image forming apparatus 1 and the external apparatus 2 can transmits/receives information to/from with each other.

The body portion 1a is configured to include the image reading section 20, the operating/displaying section 30, the printing section 40 and the image control board 100. An explanation about same configuration as the sections explained with regard to FIG. 1 is omitted by using same reference numbers.

The image control board 100 is configured to include the control section 110, a nonvolatile memory 120, the Random Access Memory (RAM) 130, the reading processing section 140, a compression IC 150, a Dynamic Random Access Memory (DRAM) control IC 160, an image memory 170, a decompression IC 180, and a writing processing section 190.

The control section 110 includes a Central Processing Unit (CPU) and the like, and reads system programs and various application programs which are stored in the nonvolatile memory 120, and a program or data which are specified among various pieces of data to expand them in the RAM 130, and executes various processing in cooperation with the program expanded in the RAM 130 to perform centralized control of the sections of the image forming apparatus 1. For example, the control section 110 switches a mode among a copy mode, printer mode and scanner mode to perform the control of copying, printing, reading of the image data, and so on, according to the instruction signal input from the operating/displaying section 30 or the external apparatus 2.

The control section 110 performs processing to allow the nonvolatile memory 120 to store the print job set by a user and the print job obtained from the external apparatus and the like according to the storage instruction of the print job input through the operating/displaying section 30 based on the print job storage program.

Moreover, the control section 110 stores and sets a predetermined condition for enabling the execution of the print job to be stored in the nonvolatile memory 120 so that the predetermined condition corresponds to the print job.

Furthermore, the control section 110 executes the print job stored in the nonvolatile memory 120 based on the print job executing program.

Especially, the control section 110 executes the print job when judging that the predetermined condition stored in the nonvolatile memory 120 is met.

The predetermined condition is a setting time for example, and when the control section 110 judges that the setting time stored in the nonvolatile memory 120 has been passed, the print job stored in the nonvolatile memory 120 is executed.

When the power of the image forming apparatus 1 is turned on, the control section 110 judges whether or not the predetermined condition stored in the nonvolatile memory 120 is met in order to execute the print job stored in the nonvolatile memory 120.

Moreover, when the power of the image forming apparatus 1 is turned on, if the print job is stored in the nonvolatile memory 120, the control section 110 executes informing processing to inform that the print job exists.

The nonvolatile memory 120 is provided with a ROM as a program memory for example, and stores a print job storing program, a condition setting program, the print job executing program, and so on in addition to various processing programs and data for forming the image.

The nonvolatile memory 120 is also provided with a Hard Disk Drive (HDD) for example, and functions as a storage section to store the print job to be reserved and data regarding a predetermined condition and the like corresponding to the print job.

The RAM 130 forms a work area in which various programs to be executed by the control section 110, various pieces of data regarding these programs, the print job and the like are temporarily stored.

The reading processing section 140 executes various processing such as analog processing, A/D converting processing, and shading processing with respect to an analog image signal input from the image reading control section 200 of the image reading section 20, and then produces a digital image data. The produced image data is output to the compression IC 150.

The compression IC 150 executes compressing processing of the input digital image data to output the image data to the DRAM control IC 160.

The DRAM control IC 160 controls compressing processing of the image data by the compression IC 150 and decompressing processing of the compressed image data by the decompression IC 180 according to the instruction from the control section 110, and controls an input/output of the image data in/from the image memory 170.

For example, when it is instructed to store the image signal read by the image reading section 20, the DRAM control IC 160 allows the compression IC 150 to execute compressing processing of the image data input from the image reading section 140 to store the compressed image data in the compression memory 171 of the image memory 170. When it is instructed to print and output the compressed image data stored in the compression memory 171, the DRAM control IC 160 reads out the compressed image data from the compression memory 171 to allow the decompression IC 180 to execute decompressing processing to store the image data in a page memory 172. When it is instructed to print and output the image data stored in the page memory 172, the DRAM control IC 160 reads out the image data from the page memory 172 to output the image data to the writing processing section 190.

The image memory 170 is provided with the compression memory 171 composed of a Dynamic RAM (DRAM) and the page memory 172. The compression memory 171 is a memory for storing the compressed image data, and the page memory 172 is a memory for temporarily storing the image data (print data) for printing and outputting.

The decompression IC 180 applies decompressing processing to the compressed image data.

The writing processing section 190 generates the print data for image formation based on the image data input from the DRAM control IC 160 to output the print data to the printing section 40.

The image reading section 20 is composed of a CCD 22a, the image reading control section 200, and in addition, though not illustrated here, the automatic document feeding section 21, the reading section 22, and so on which are shown in FIG. 1. The image reading control section 200 controls the automatic document feeding section 21, the reading section 22, and the like to allow them to execute exposing and scanning of a document surface so that the CCD 22a performs photoelectric conversion to the reflected light so as to read the image. The read analog image signal is output to the image processing section 140.

The operating/displaying section 30 is composed of the LCD 31, the touch panel 32, an operating/displaying control section 300, and an operation key group including numeric keypad.

The operating/displaying control section 300 allows the LCD 31 to display various screens for inputting various setting conditions and various processing results according to a display signal input from the control section 110. The operating/displaying control section 300 also outputs an operation signal input from various switches and buttons, numeric keypad, operation key group or touch panel 32 to the control section 110.

For example, the operating/displaying section 30 functions as an input section for instructing to store the print job in the nonvolatile memory 120.

Moreover, the operating/displaying section 30 functions as a condition setting section to store and set a setting time which is the predetermined condition for enabling an execution of the print job so that the predetermined condition corresponds to the print job to be stored in the nonvolatile memory 120.

The operating /displaying section 30 also has a function to execute displaying so as to inform that the print job is stored in the nonvolatile memory 120 to a user.

The printing section 40 is configured to include the sections such as the image forming section 43 shown in FIG. 1 related to printing and outputting, and the print control section 400.

The print control section 400 controls an operation of each section such as the image forming section 43 of the printing section 40 according to the instruction from the control section 110 to perform image formation on the sheet P based on the print data input from the writing processing section 190, and outputs an instruction signal for allowing each section of the finishing section 50 to operate, to the finishing control section 500, according to the instruction from the control section 110.

The finishing section 50 is provided with various finishing units, a conveyance member such as a conveyance roller to convey the sheets to various finishing units, and the discharge tray T3 to which the sheets conveyed from the various finishing units are discharged. The various finishing units are integrally controlled by the finishing control section 500.

The finishing control section 500 conveys the sheet P along a conveyance path to the predetermined finishing unit according to the instruction signal as to finishing input from the control section 110 through the print control section 400, and drives and controls each of the sections to perform various finishing processing to discharge the sheet P to the discharge tray T3.

The fingerprint authenticating section 60 functions as a condition setting section and an authentication input section to receive an input of a fingerprint of a user. The fingerprint authenticating section 60 reads fingerprint data which is authentication information of a user depending on a predetermined operation to output the fingerprint data to the control section 110.

Next, each section of the printer controller 1b will be described.

The printer controller 1b performs management and control of the print job input from the external apparatus 2 connected to the network 3 to the image forming apparatus 1 when the image forming apparatus 1 is used as a network printer. The print controller 1b receives data to be printed from the external apparatus 2 and transmits the data as the print job to the body portion 1a.

The print controller 1b is composed of a controller control section 11, DRAM control IC 12, image memory 13, and LANIF 14.

The controller control section 11 integrally controls an operation of each section of the printer controller 1b, and transmits the data input from the external apparatus 2 as the print job to the body portion 1a through the LANIF 14.

The DRAM control IC 12 controls storing of the data received by the LANIF 14 to the image memory 13, and reading out of the data from the image memory 13. The DRAM control IC 12 is connected to the DRAM control IC 160 of the image control board 100 with a Peripheral Components Interconnect (PCI) bus, and reads out the data to be printed from the image memory 13 to output the data to the DRAM control IC 160 according to the instruction from the controller control section 11.

The image memory 13 is composed of a DRAM, and temporarily stores the input data to be output.

The LANIF 14 is a communication interface for connecting to the network 3 such as LAN including Network Interface Card (NIC) and modem, and receives the data from the external apparatus 2. The received data is output to the DRAM control IC 12.

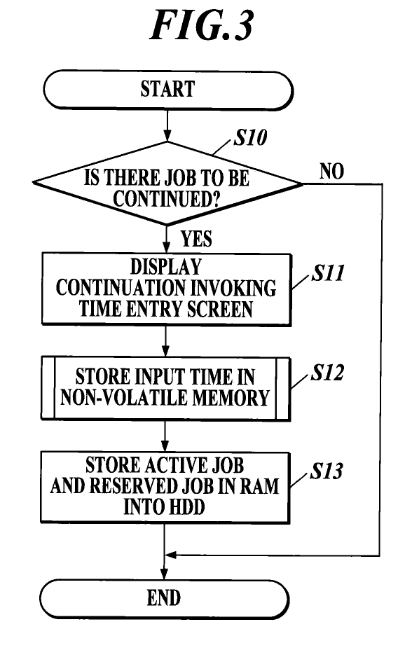

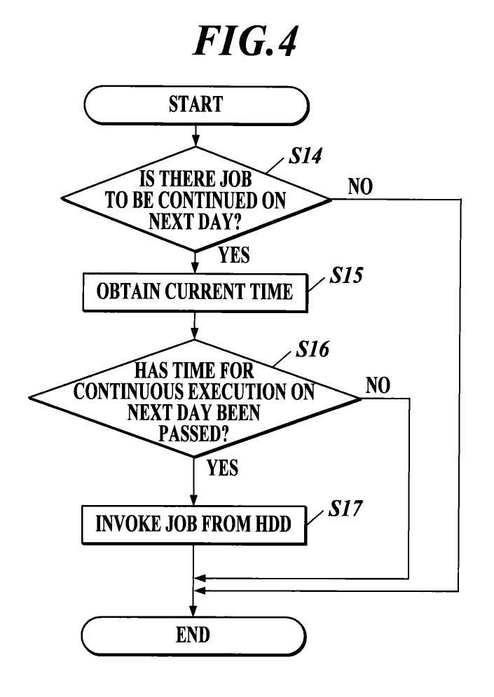

Next, an operation or processing by the image forming apparatus 1 according to the first embodiment will be described with reference to flowcharts shown in FIGS. 3, 4.

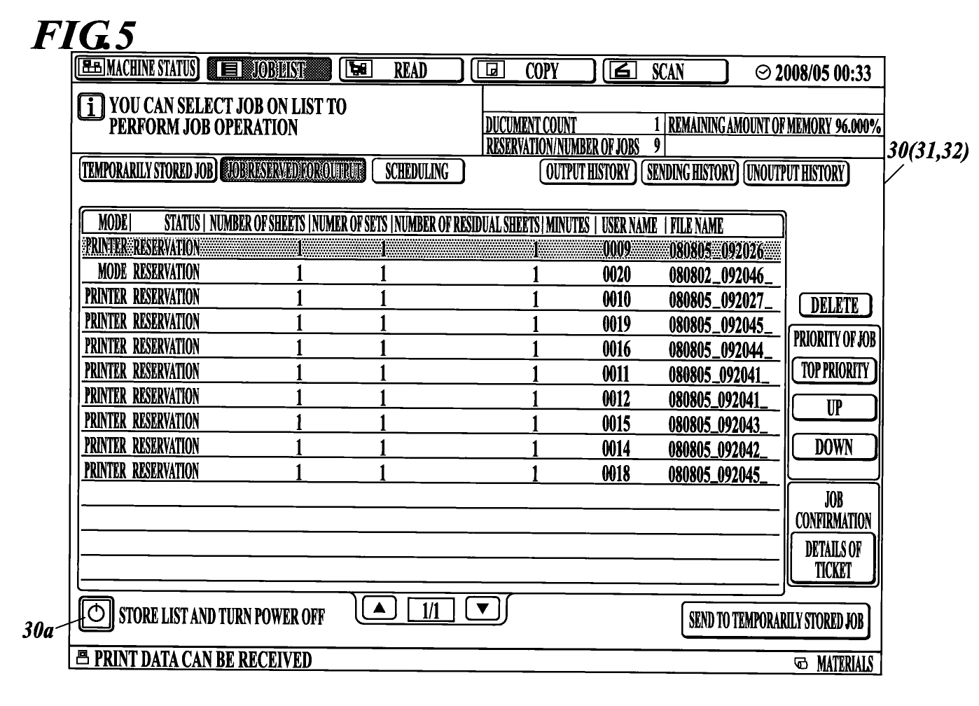

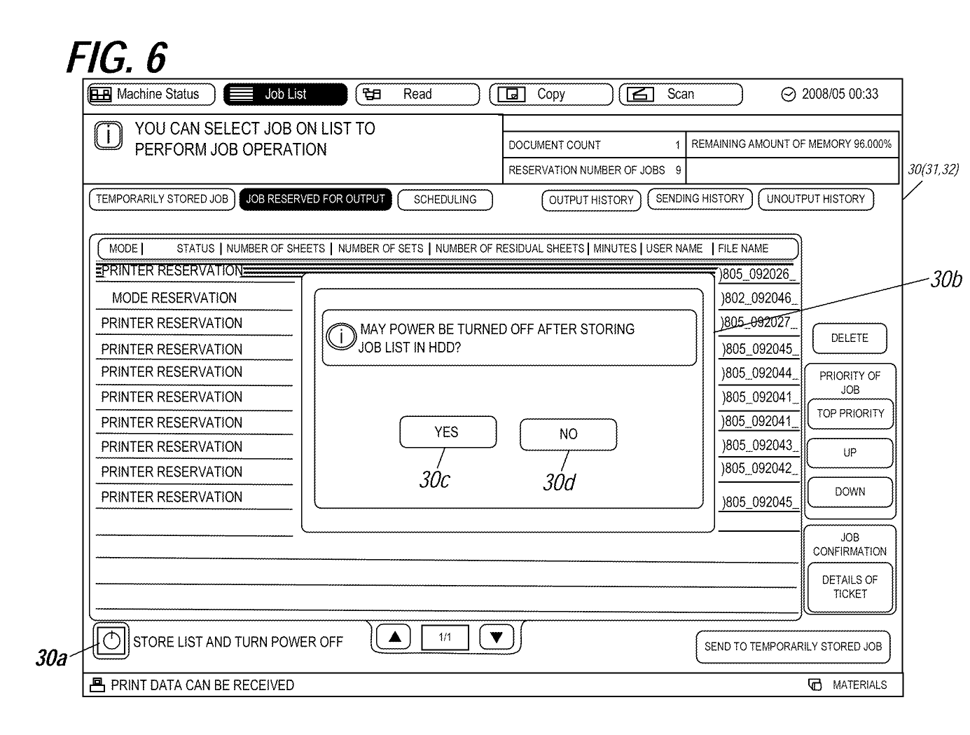

For example, when a user sets the print job like that displayed in the operating/displaying section 30 shown in FIG. 5 to reserve the print job for executing it on the next day, by depressing a job reservation button 30a in the operating/displaying section 30, a job reservation screen 30b is displayed in the operating/displaying section 30 as shown in FIG. 6.

When “No” key 30d in the job reservation screen 30b is depressed (Step S10: No), the reservation is not performed and the power of the image forming apparatus 1 is turned off and the processing ends.

On the other hand, when “Yes” key 30c in the job reservation screen 30b is depressed to instruct to store the print job (Step S10: Yes), the operating/displaying section 30 displays a setting time entry screen (Step S11).

When a user inputs the desired time in the setting time entry screen (not shown) in the operating/displaying section 30, the control section 110 stores the input setting time in the nonvolatile memory 120 so that the setting time corresponds to the print job (Step S12), and the print job to which the setting time is correlated is stored in the nonvolatile memory 120 (Step S13). After storing the print job, the power of the image forming apparatus 1 is turned off and the processing ends.

After that, when the power of the image forming apparatus 1 is turned on, the control section 110 judges whether or not the reserved print job stored in the nonvolatile memory 120 exists (Step S14).

When the control section 110 judges that the print job is not stored in the nonvolatile memory 120 (Step S14: No), the control section 110 normally activates the image forming apparatus 1 and allows the processing to end.

On the other hand, when the control section 110 judges that the print job is stored in the nonvolatile memory 120 (Step S14: Yes), the control section 110 obtains current time (Step S15) and judges whether or not the setting time has been passed (Step S16).

When the control section 110 judges that the current time does not reach to the setting time (Step S16: No), the control section 110 normally activates the image forming apparatus 1 and allows the processing to end.

On the other hand, when the control section 110 judges that the current time reaches the setting time or the setting time has been already passed so that the predetermined condition is met (Step S16: Yes), the control section 110 invokes the print job stored in the nonvolatile memory 120 as shown in FIG. 5 (Step S17), activates the image forming apparatus 1 so that the print job can be executed, and allows the processing to end.

As described above, since the print job reserved by a user remains stored in the nonvolatile memory 120 until the time which a user desires comes even when activating the image forming apparatus 1, there is no possibility that the print job is lost due to deletion by the third person during absence of a user.

Incidentally, the image forming apparatus 1 needs not to be normally activated immediately when the control section 110 judges that the current time does not reach to the setting time.

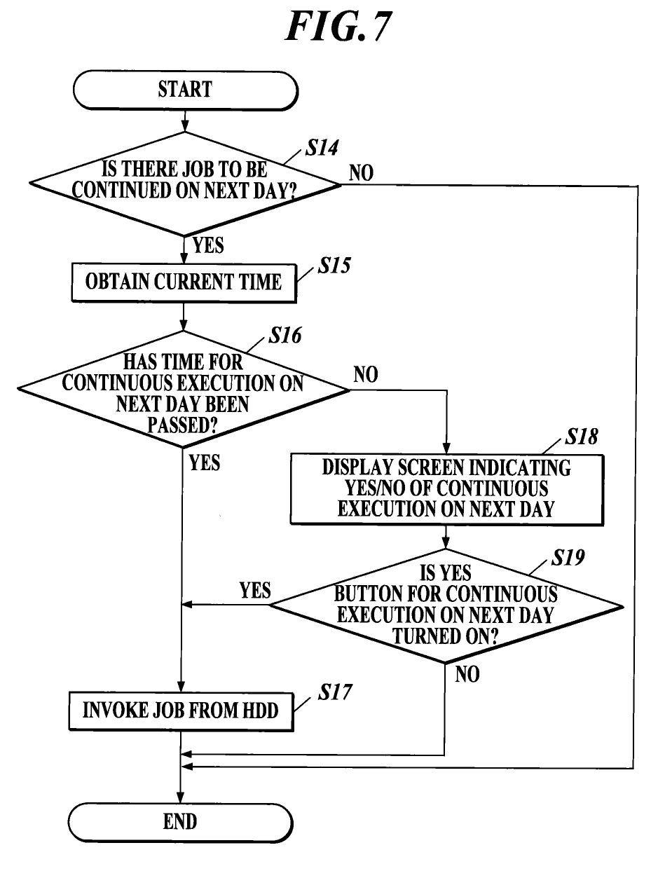

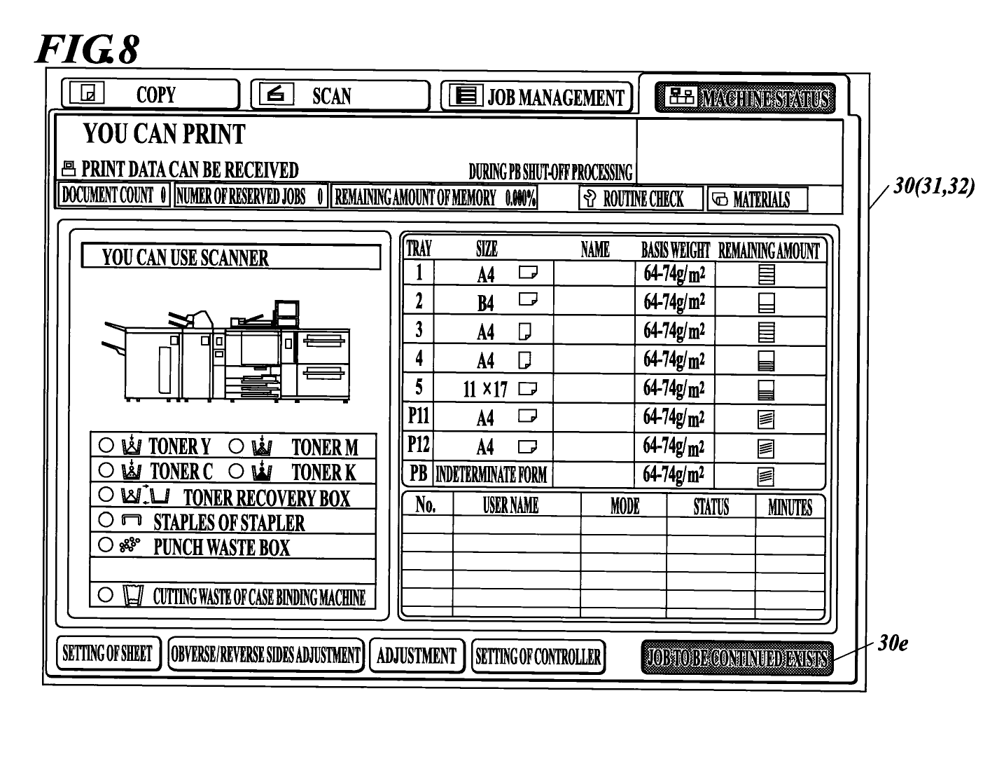

For example, when the control section 110 judges that the current time does not reach to the setting time (Step S16: No) as a flowchart shown in FIG. 7, the operating/displaying section 30 may display a continuous-job-presence key 30e to inform that the print job is stored in the nonvolatile memory 120 as shown in FIG. 8.

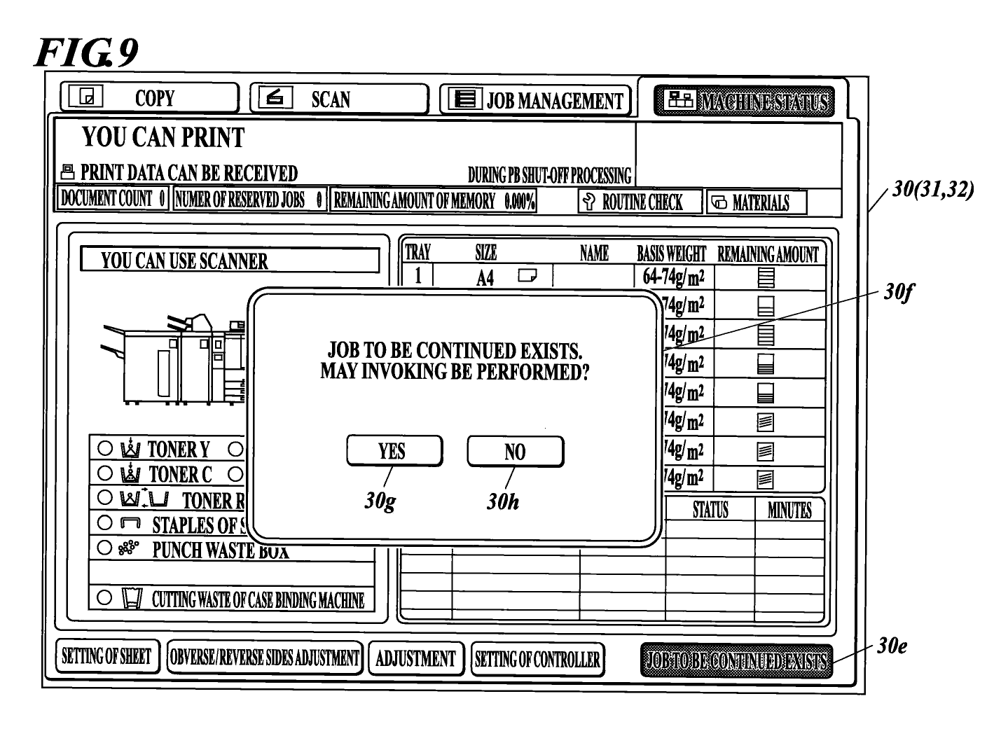

When the continuous-job-presence key 30e is depressed, a job-execution-agree/disagree screen 30f is displayed in the operating/displaying section 30 as shown in FIG. 9 (Step S18).

When a “No” key 30h in the job-execution-agree/disagree screen 30f is depressed (Step S18: No), the image forming apparatus 1 is normally activated and the processing ends.

On the other hand, when a “Yes” key 30g in the job-execution-agree/disagree screen 30f is depressed (Step S18: Yes), the print job stored in the nonvolatile memory 120 is invoked (Step S17), the image forming apparatus 1 is activated so as to be able to execute the print job, and the processing ends.

Thus, even when the current time does not reach to the setting time previously set by a user when the image forming apparatus 1 is activated, if a user intends to execute the print job, the print job can be invoked to be executed.

As described above, according to the image forming apparatus 1, the print job reserved by a user remains stored in the nonvolatile memory 120 until the setting time set by a user comes or until a user instructs to execute the print job even when the image forming apparatus 1 is activated, these is no possibility that the print job is lost due to a wrong operation by the third person during absence of a user.

In other words, since the reserved print job can be selectively invoked based on the setting time as the predetermined condition, these is no possibility that the print job is lost despite the intension of a user, and it becomes possible to unfailingly execute the print job.

### Second Embodiment

Next, the second embodiment of the image forming apparatus according to the present invention will be described. The same reference numbers as the first embodiment is applied to the same portions, and only different points will be described.

The operating/displaying section 30 functions as a condition setting section to store and set a password which is authentication information as the predetermined condition for enabling execution of the print job so that the password corresponds to the print job to be stored in the nonvolatile memory 120.

The operating/displaying section 30 functions also as an authentication input section in which a user input a password as the authentication information.

The control section 110 performs processing of storing the print job set by a user or the print job obtained from the external apparatus or the like in the nonvolatile memory 120 according to the instruction to store the print job input through the operating/displaying section 30 based on a print job storing program.

The control section 110 further performs processing of storing and setting the password which is the authentication information as the predetermined condition for enabling execution of the print job so that the password corresponds to the print job to be stored in the nonvolatile memory 120, based on a condition setting program.

The control section 110 performs processing of executing the print job stored in the nonvolatile memory 120 when judging that the password stored in the nonvolatile memory 120 and the password input through the operating/displaying section 30 agree with each other.

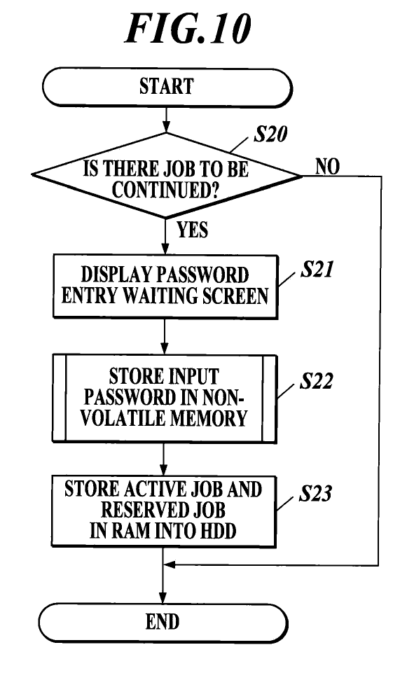

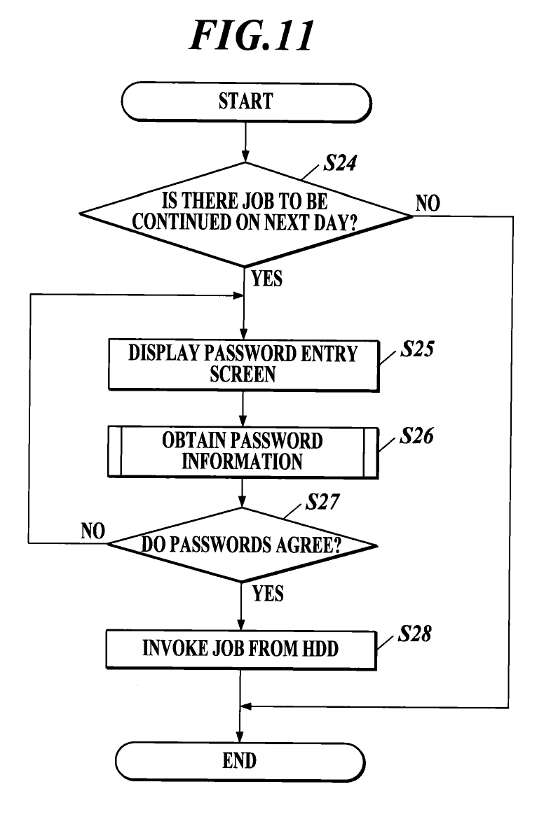

The operation and processing by the image forming apparatus according to the second embodiment will be described with reference to the flowcharts shown in FIGS. 10, 11.

For example, when a user sets the print job like that displayed in the operating/displaying section 30 shown in FIG. 5 to reserve the print job for executing it on the next day, by depressing the job reservation button 30a in the operating/displaying section 30, the job reservation screen 30b is displayed in the operating/displaying section 30 as shown in FIG. 6.

When “No” key 30d in the job reservation screen 30b is depressed (Step S20: No), the reservation is not performed, the power of the image forming apparatus 1 is turned off and the processing ends.

On the other hand, when “Yes” key 30c in the job reservation screen 30b is depressed to instruct to store the print job (Step S20: Yes), the operating/displaying section 30 displays a password setting screen (Step S21).

When a user inputs the password in the password setting screen (not shown) in the operating/displaying section 30, the control section 110 stores the password in the nonvolatile memory 120 correspondingly to the print job (Step S22), and stores the print job to which the password is correlated in the nonvolatile memory 120 (Step S23). After storing the print job, the power of the image forming apparatus 1 is turned off and the processing ends.

After that, when the power of the image forming apparatus 1 is turned on, the control section 110 judges whether or not the reserved print job stored in the nonvolatile memory 120 exists (Step S24).

When the control section 110 judges that the print job is not stored in the nonvolatile memory 120 (Step S24: No), the image forming apparatus 1 is normally activated and the processing ends.

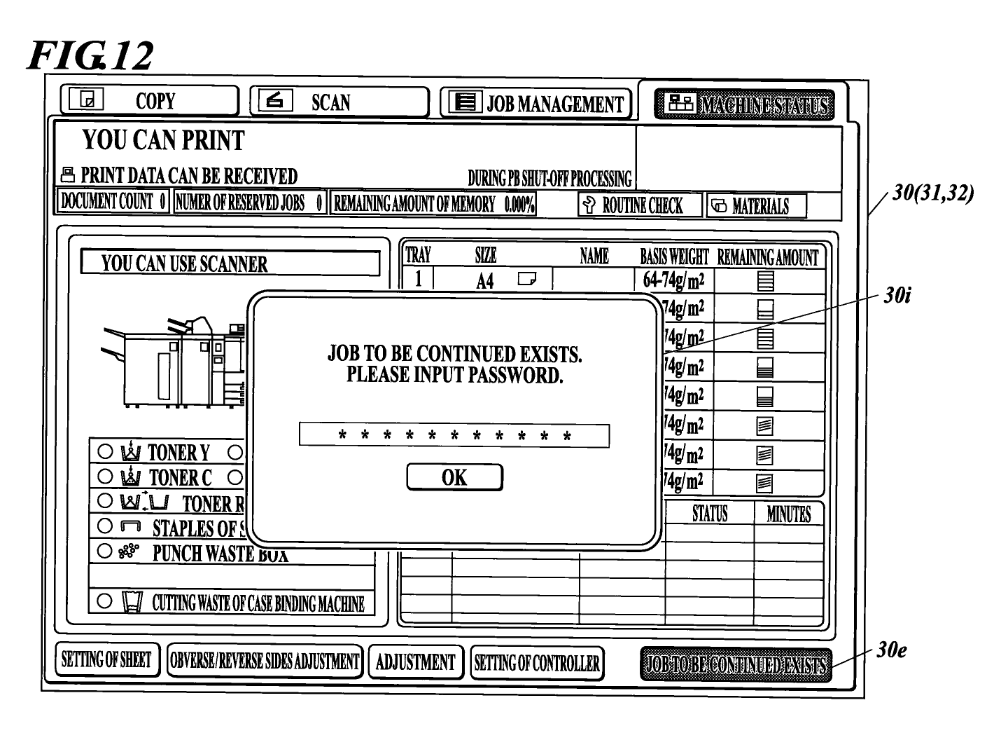

On the other hand, when the control section 110 judges that that the print job is stored in the nonvolatile memory 120 (Step S24: Yes), the operating/displaying section 30 displays a password entry screen 30i as shown in FIG. 12 (Step S25).

When the password is input in the password entry screen 30i (Step S26), the control section 110 judges that whether or not the password stored and set in the nonvolatile memory 120 and the password input through the operating/displaying section 30 agree with each other (Step S27).

When the control section 110 judges that the passwords do not agree with each other (Step S27: No), the processing returns to Step S25. When each of the multiple (for example, three) input passwords does not agree with the set password, the image forming apparatus 1 is normally activated and the processing ends.

On the other hand, when the control section 110 judges that the passwords agree with each other (Step S27: Yes), the print job stored in the nonvolatile memory 120 is invoked as shown in FIG. 5 (Step S28), the image forming apparatus 1 is activated so as to be able to execute the print job, and the processing ends.

As described above, according to the image forming apparatus 1, since the print job reserved by a user remains stored in the nonvolatile memory 120 until the password set by the user is input so that the print job is selectively invoked based on the authentication of the password even when the image forming apparatus 1 is activated, there is no possibility that the print job is lost despite the intention of the user, and thereby the print job can be surely executed.

### Third Embodiment

Next, the third embodiment of the image forming apparatus according to the present invention will be described. The same reference numbers as the first embodiment is applied to the same portions, and only different points will be described.

The fingerprint authenticating section 60 functions as a condition setting section to store and set the fingerprint data which is the authentication information as the predetermined condition for enabling the execution of the print job in the nonvolatile memory 120 so that the fingerprint data corresponds to the print job to be stored in the nonvolatile memory 120.

The fingerprint authenticating section 60 further functions as an authentication input section for inputting the fingerprint data as the authentication information.

The control section 110 performs processing of storing the print job set by a user and the print job obtained from the external apparatus and the like in the nonvolatile memory 120 according to the instruction to store the print job input through the operating/displaying section 30 based on the print job storing program.

The control section 110 also performs processing of storing and setting the fingerprint data which is the authentication information as the predetermined condition for enabling the execution of the print job in the nonvolatile memory 120 so that the fingerprint data corresponds to the print job to be stored in the nonvolatile memory 120, based on the condition setting program.

Then, when the control section 110 judges that the fingerprint data stored in the nonvolatile memory 120 and the fingerprint data input through the fingerprint authenticating section 60 agree with each other, the control section 110 performs processing of executing the print job stored in the nonvolatile memory 120.

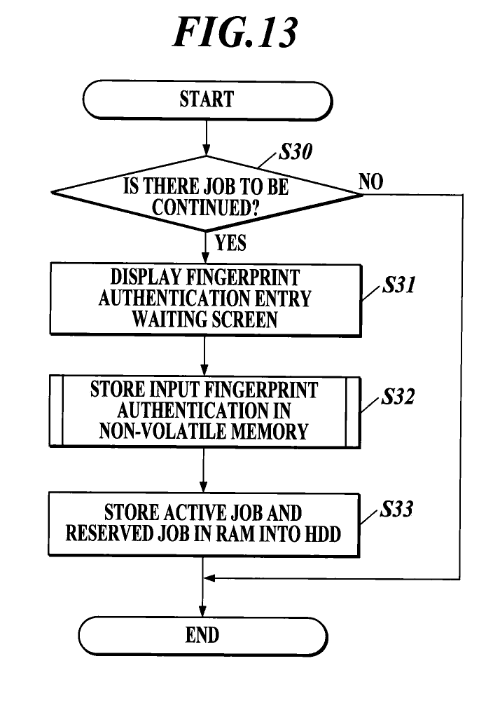

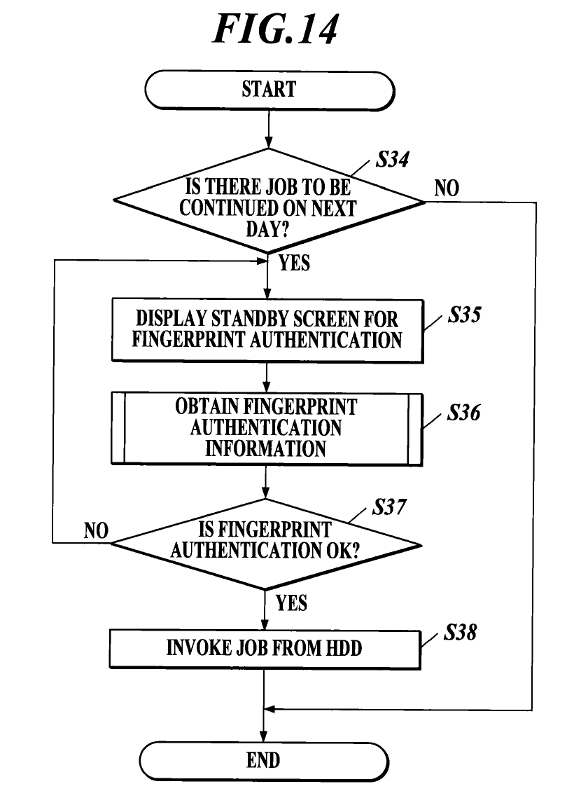

The operation and processing by the image forming apparatus 1 according to the third embodiment will be described with reference to the flowcharts shown in FIGS. 13, 14.

For example, when a user sets the print job like that displayed in the operating/displaying section 30 shown in FIG. 5 to reserve the print job for executing it on the next day, by depressing the job reservation button 30a in the operating/displaying section 30, the job reservation screen 30b is displayed in the operating/displaying section 30 as shown in FIG. 6.

When the “No” key 30d in the job reservation screen 30b is depressed (Step S30: No), the power of the image forming apparatus 1 is turned off without performing the reservation, and the processing ends.

On the other hand, when the “Yes” key 30c in the job reservation screen 30b is depressed to instruct to store the print job (Step S30: Yes), the fingerprint data setting screen is displayed in the operating/displaying section 30 (Step S31).

When a user inputs the fingerprint data through the fingerprint authenticating section 60 according to the instruction of the fingerprint data setting screen (not shown) in the operating/displaying section 30, the control section 110 stores the fingerprint data in the nonvolatile memory 120 so that the fingerprint data corresponds to the print data (Step S32), and stores the print job to which the fingerprint data is correlated in the nonvolatile memory 120 (Step S33). After storing the print job, the power of the image forming apparatus 1 is turned off and the processing ends.

After that, when the power of the image forming apparatus 1 is turned on, the control section 110 judges whether or not the reserved print job stored in the nonvolatile memory 120 exists (Step S34).

When the control section 110 judges that the print job is not stored in the nonvolatile memory 120 (Step S34: No), the image forming apparatus 1 is normally activated and the processing ends.

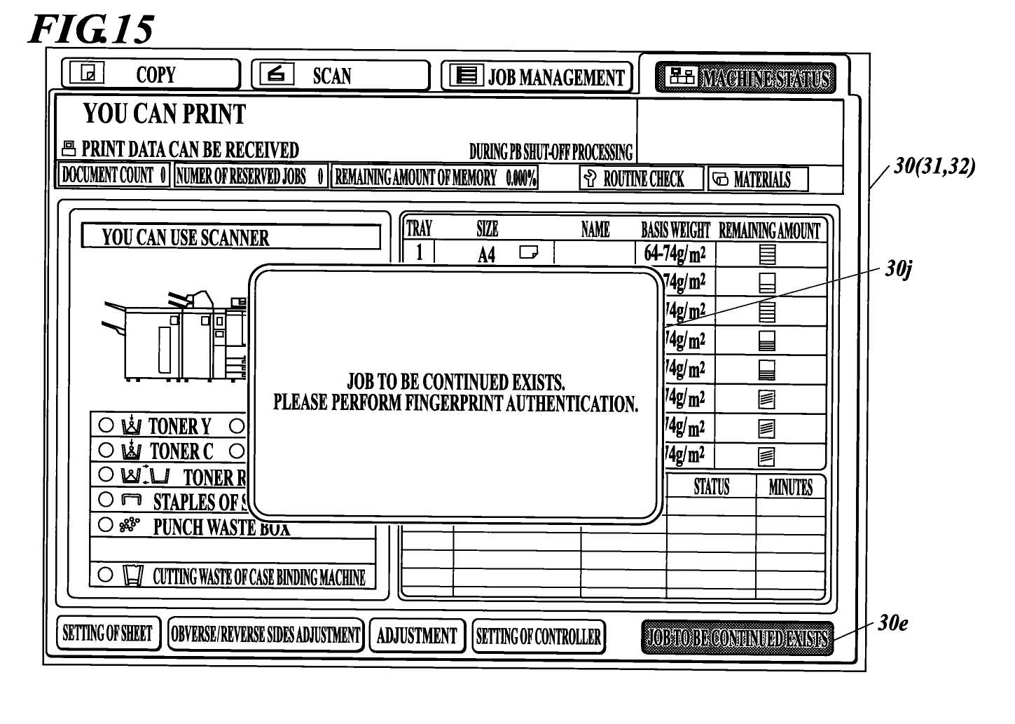

On the other hand, when the control section 110 judges that the print job is stored in the nonvolatile memory 120 (Step S34: Yes), the fingerprint data entry screen 30j is displayed in the operating/displaying section 30 as shown in FIG. 15 (Step S35).

When a user inputs the fingerprint data through the fingerprint authenticating section 60 according to the instruction in the fingerprint data entry screen 30j (Step S36), the control section 110 judges whether or not the fingerprint data stored and set in the nonvolatile memory 120 and the fingerprint data input through the fingerprint authenticating section 60 agree with each other (Step S37).

When the control section 110 judges that the couple of pieces of the fingerprint data do not agree with each other (Step S37: No), the processing returns to Step S35. When each of a plurality (for example, three) of pieces of input fingerprint data does not agree with the set fingerprint data, the image forming apparatus 1 is normally activated and the processing ends.

On the other hand, when the control section 110 judges that the couple of pieces of the fingerprint data agree with each other (Step S37: Yes), the print job stored in the nonvolatile memory 120 is invoked (Step S38), the image forming apparatus 1 is activated so as to be able to execute the print job, and the processing ends.

As described above, according to the image forming apparatus 1, since the print job reserved by a user remains stored in the nonvolatile memory 120 until the fingerprint data set by the user is input so that the print job is selectively invoked based on the authentication of the fingerprint data even when the image forming apparatus 1 is activated, there is no possibility that the print job is lost despite the intention of the user, and thereby the print job can be surely executed.

### Fourth Embodiment

Next, the fourth embodiment of the image forming apparatus according to the present invention will be described. The same reference numbers as the first embodiment is applied to the same portions, and only different points will be described.

The operating/displaying section 30 functions as a selection section for enabling a user to arbitrarily select a condition among a plurality of conditions for enabling the execution of the print job.

The control section 110 performs processing of executing the print job when judging that the predetermined condition stored in the nonvolatile memory 120 is met.

The predetermined condition is, for example, setting time, password, or fingerprint data. When the control section 110 judges that the current time reaches the setting time stored in the nonvolatile memory 120 or the setting time has been passed, or when the control section 110 judges that the password stored in the nonvolatile memory 120 and the password input through the operating/displaying section 30 agree with each other, or when the control section 110 judges that the fingerprint data stored in the nonvolatile memory 120 and the fingerprint data input through the fingerprint authenticating section 60 agree with each other, the print job stored in the nonvolatile memory 120 is executed.

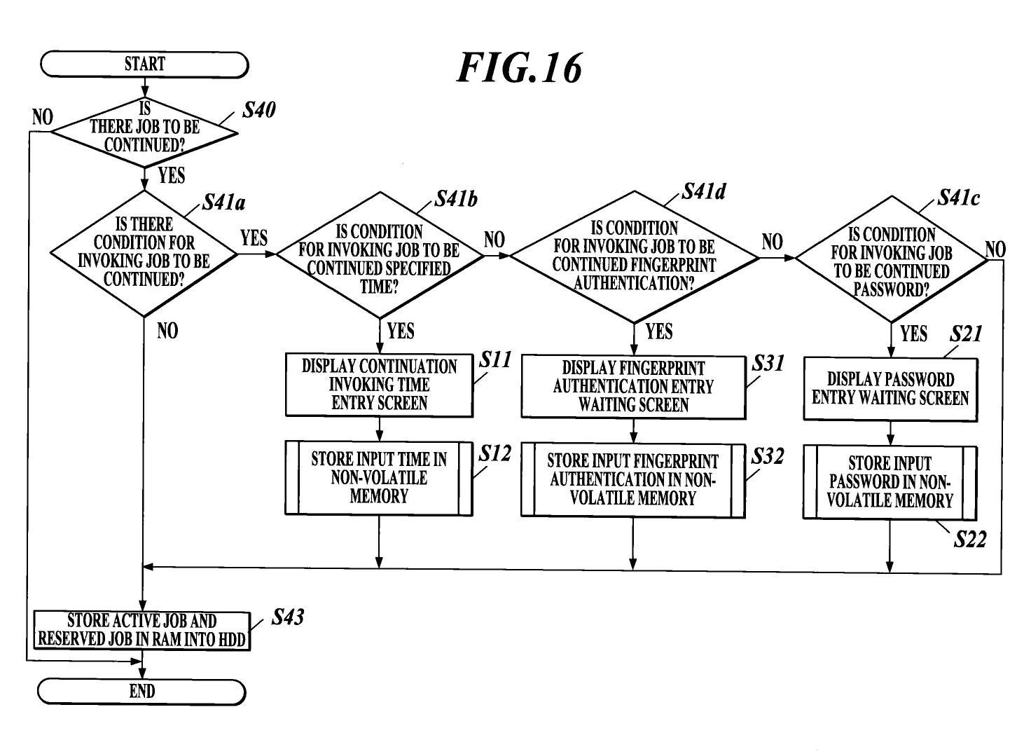

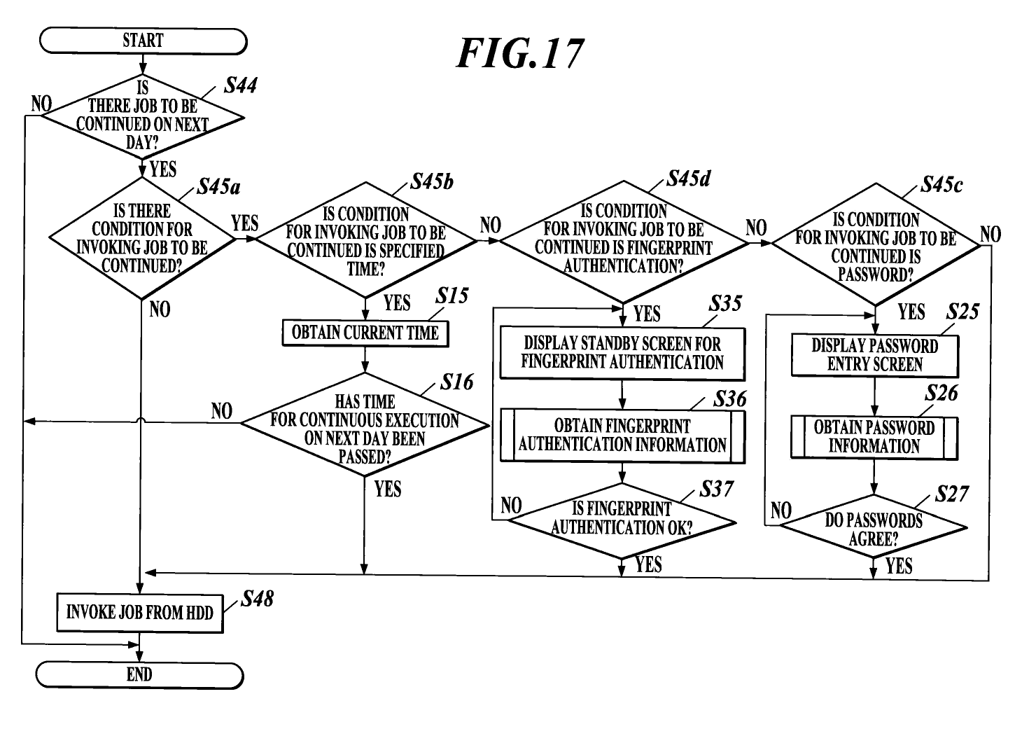

The operation and processing by the image forming apparatus 1 according to the fourth embodiment will be described with reference to flowcharts shown in FIGS. 16, 17.

For example, when a user sets the print job like that displayed in the operating/displaying section 30 shown in FIG. 5 to reserve the print job for executing it on the next day, by depressing the job reservation button 30a in the operating/displaying section 30, the job reservation screen 30b is displayed in the operating/displaying section 30 as shown in FIG. 6.

When the “No” key 30d in the job reservation screen 30b is depressed (Step S40: No), the power of the image forming apparatus 1 is turned on without performing the reservation, and the processing ends.

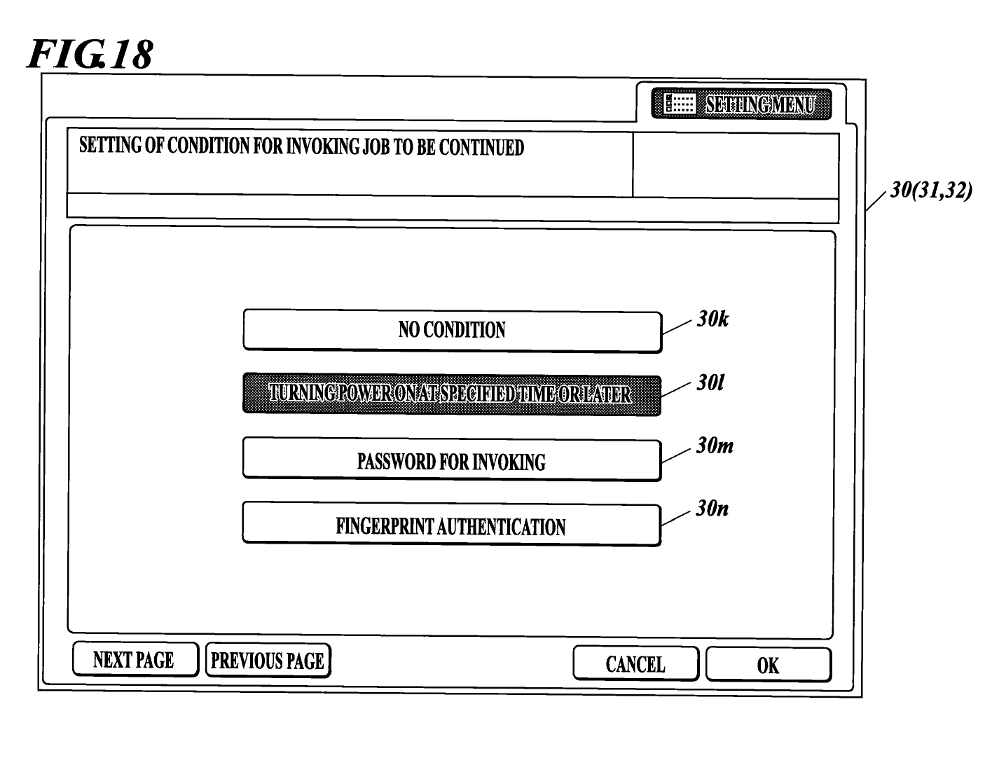

On the other hand, when the “Yes” key 30c is depressed to instruct to store the print job (Step S40: Yes), the condition selection screen is displayed in the operating/displaying section 30 as shown in FIG. 18 (Step S41 (S41a, S41b, S41c, S41d)).

When a “no condition” key 30k is depressed in the condition selection screen (Step S41a: Yes), only the print job is stored in the nonvolatile memory 120 (Step S43). After storing the print job, the power of the image forming apparatus 1 is turned off and the processing ends.

When a “setting time” key 30l is depressed in the condition selection screen (Step S41b: Yes), the processing goes through Steps S11, S12, and then the print job to which the setting time is correlated is stored in the nonvolatile memory 120 (Step S43). After storing the print job, the power of the image forming apparatus 1 is turned off and the processing ends.

When a “password” key 30m is depressed in the condition selection screen (Step S41c: Yes), the processing goes through Steps S21, S22, and then the print job to which the password is correlated is stored in the nonvolatile memory 120 (Step S43). After storing the print job, the power of the image forming apparatus 1 is turned off and the processing ends.

When a “fingerprint data” key 30n is depressed in the condition selection screen (Step S41d: Yes), the processing goes through Steps S31, S32, and then the print job to which the fingerprint data is correlated is stored in the nonvolatile memory 120 (Step S43). After storing the print job, the power of the image forming apparatus 1 is turned off and the processing ends.

After that, when the power of the image forming apparatus 1 is turned on, the control section 110 judges that whether or not the reserved print job stored in the nonvolatile memory 120 exits (Step S44).

When the control section 110 judges that the print job is not stored in the nonvolatile memory 120 (Step S44: No), the image forming apparatus 1 is normally activated and the processing ends.

On the other hand, when the control section 110 judges that the print job is stored in the nonvolatile memory 120 (Step S44: Yes), the control section 110 judges what the selected predetermined condition is (Step S45 (S45a, S45b, S45c, S45d)).

When the control section 110 judges that no condition is selected (Step S45a: Yes), the print job stored in the nonvolatile memory 120 is invoked as shown in FIG. 5 (Step S48), the image forming apparatus 1 is activated so as to be able to execute the print job, and the processing ends.

When the control section 110 judges that the predetermined condition is the setting time (Step S45b: Yes), the processing goes through Steps S15, S16.

Then, when the control section 110 judges that the current time does not reach to the setting time (Step S16: No), the image forming apparatus 1 is normally activated, and the processing ends. On the other hand, when the control section 110 judges that the current time reaches the setting time or the setting time has been passed (Step S16: Yes), the print job stored in the nonvolatile memory 120 is invoked as shown in FIG. 5 (Step S48), the image forming apparatus 1 is activated so as to be able to execute the print job, and the processing ends.

When the control section 110 judges that the predetermined condition is the password (Step S45c: Yes), the processing goes through Steps S25, S26 and S27.

Then, when the control section 110 judges that the passwords do not agree with each other (Step S27: No), the processing returns to Step S25. On the other hand, when the control section 110 judges that the passwords agree with each other (Step S27: Yes), the print job stored in the nonvolatile memory 120 is invoked as shown in FIG. 5 (Step S48), the image forming apparatus 1 is activated so as to be able to execute the print job, and the processing ends. When each of the multiple (for example, three) input passwords does not agree with the set password, the image forming apparatus 1 is normally activated and the processing ends.

When the control section 110 judges that the predetermined condition is the fingerprint data (Step S45d: Yes), the processing goes through Steps S35, S36 and S37.

Then, when the control section 110 judges that the couple of pieces of the finger print data do not agree with each other (Step S37: No), the processing returns to Step S35. On the other hand, when the control section 110 judges that the couple of pieces of the finger print data agree with each other (Step S37: Yes), the print job stored in the nonvolatile memory 120 is invoked as shown in FIG. 5 (Step S48), the image forming apparatus 1 is activated so as to be able to execute the print job, and the processing ends. When each of a plurality (for example, three) of pieces of the fingerprint data does not agree with the set fingerprint data, the image forming apparatus 1 is normally activated and the processing ends.

As described above, the image forming apparatus 1 can store a plurality of conditions in the nonvolatile memory 120 so that a user can select desired condition among the plurality of conditions.

According to the image forming apparatus 1, since the print job reserved by a user remains stored in the nonvolatile memory 120 until the predetermined condition set by the user is met even when the image forming apparatus 1 is activated, and since the print job is invoked when it is judged that the condition is met, there is no possibility that the print job is lost despite the intention of the user, and thereby the print job can be surely executed.

Incidentally, though the above-mentioned embodiment recites password and fingerprint data as examples of the authentication information, the present invention is not limited to the examples, and arbitrary authentication information such as biometric authentication may be used.

In addition, it is a matter of course that specific detailed configuration and the like can be changed arbitrary.

All of the disclosures including the claims, the patent specification, the attached drawings and the abstract of Japanese Patent Application No. 2008-281952 filed Oct. 31, 2008 are herein incorporated by reference.

Although various typical embodiments have been shown and described, the present invention is not limited to those embodiments. Consequently, the scope of the present invention can be limited only by the following claims.

What is claimed is:

1. An image forming apparatus comprising:
a nonvolatile storage section to store a print job;
an input section for instructing to store the print job in the storage section;
a condition setting section to allow the storage section to store a predetermined condition for enabling execution of the print job so that the predetermined condition corresponds to the print job; and
a control section to execute the print job stored in the storage section,
wherein the control section executes the print job when the control section judges that the predetermined condition stored in the storage section is met.

2. The image forming apparatus of claim 1, wherein the control section judges whether or not the predetermined condition stored in the storage section is met in order to execute the print job stored in the storage section when a power of the image forming apparatus is turned on.

3. The image forming apparatus of claim 1, wherein the control section informs that the print job exists if the print job is stored in the storage section when a power of the image forming apparatus is turned on.

4. The image forming apparatus of claim 1,
wherein the storage section stores a setting time as the condition, and
wherein control section executes the print job when the control section judges that a current time reaches the setting time or that the setting time has been passed.

5. The image forming apparatus of claim 1 further comprising an authentication input section in which a user inputs authentication information,
wherein the control section executes the print job when the control section judges that authentication information input in the authentication input section agrees with authentication information stored in the storage section as the condition.

6. The image forming apparatus of claim 5, wherein the authentication information is a password.

7. The image forming apparatus of claim 5, wherein the authentication information is fingerprint data.

8. The image forming apparatus of claim 1,
wherein the storage section stores a plurality of conditions,
wherein the image forming apparatus further includes a selection section in which a user arbitrary selects a condition among the plurality of conditions, and
wherein the control section performs judgment for executing the print job stored in the storage section based on the selected condition.

9. An image forming method using an image forming apparatus provided with a nonvolatile storage section, the method comprising the steps of:
storing a print job for forming an image and a predetermined condition for enabling execution of the print job in the storage section so that the predetermined condition corresponds to the print job; and
executing the print job to form the image when the predetermined condition stored in the storage section is met.

10. The image forming method of claim 9, wherein judging whether or not the predetermined condition stored in the storage section is met is performed when a power of the image forming apparatus is turned on.

11. The image forming method of claim 9, wherein informing that the print job exists is performed if the print job is stored in the storage section when a power of the image forming apparatus is turned on.

12. The image forming method of claim 9,
wherein the storage section stores a setting time as the condition, and
wherein the print job is executed when a current time reaches the setting time or the setting time has been passed.

13. The image forming method of claim 9,
wherein the image forming apparatus includes an authentication input section in which a user inputs authentication information, and
wherein the print job is executed when authentication information input in the authentication input section agrees with authentication information stored in the storage section as the condition.

14. The image forming method of claim 13, wherein the authentication information is a password.

15. The image forming method of claim 13, wherein the authentication information is fingerprint data.

16. The image forming method of claim 9,
wherein the storage section stores a plurality of conditions,
wherein the image forming apparatus includes a selection section in which a user arbitrary selects a condition among the plurality of conditions, and
wherein judgment for executing the print job stored in the storage section is performed based on the condition selected in the selection section.
